(19) United States
(12) Patent Application Publication
(10) Pub. No.: US 2025/0250132 A1
(43) Pub. Date: Aug. 7, 2025

(54) METHOD FOR LOADING A CHERRY PICKER ONTO A TRAILER OR A TRANSPORT PLATFORM, AND CHERRY PICKER ABLE TO CARRY OUT THE METHOD

(71) Applicant: MANITOU BF, ANCENIS (FR)

(72) Inventors: Régis MARZIN, ANCENIS (FR); Michelle GARCIA PRIETO, ANCENIS (FR)

(21) Appl. No.: 18/841,155

(22) PCT Filed: Mar. 23, 2023
(86) PCT No.: PCT/FR2023/050415

§ 371 Date: Apr. 10, 2025

(30) Foreign Application Priority Data
Mar. 24, 2022 (FR) FR2202623

(51) Int. Cl. B65G 67/04; B66F 11/04

(52) U.S. Cl. CPC B65G 67/04; B66F 11/044

(57) ABSTRACT

A method for loading an aerial lift onto a trailer, the lift including a wheeled chassis, a working platform, a lifting structure including a lifting boom and a pendulum, a remote control unit and an operating unit configured to move the lifting structure, the working platform and the wheeled chassis based on data from the remote control unit.

In a loading position and in a compact folded transportation position, the pendulum arm is folded underneath the lifting boom. The method comprises, in order to load the aerial lift onto a trailer, a step of making the lifting structure and the working platform move up to the loading position and a step of using the remote control unit to make the chassis move in order to position the lift, which is in the loading position, on the trailer.

The present invention relates to a method for loading an aerial lift onto a trailer or a flatbed truck, and to an aerial lift capable of implementing said method.

It relates in particular to a method for loading an aerial lift onto a trailer or a flatbed truck, said lift comprising a chassis provided with members for movement on the ground defining a plane in which the chassis rests on the ground when the chassis is positioned on a horizontal flat surface, a working platform comprising a floor and a guard rail, a lifting structure, a telecontrol unit, also referred to as remote control unit, and an operating unit configured to make at least the lifting structure and the working platform move according at least to data supplied by the remote control unit, said lifting structure comprising at least a lifting boom and a pendulum arm coupled at one end to the lifting boom and at the opposite end to the working platform, said lifting boom being a boom which can pivot between a topmost position and a bottommost position, this bottommost position corresponding to the position in which the lifting boom is lowered all the way down and/or the position in which at least part of the working platform makes contact with the ground, and said lift having, in addition to a working position, a compact folded transportation position in which the pendulum arm is folded underneath the lifting boom and the lifting boom is in the bottommost position.

Such aerial lifts with a working position in which the pendulum arm does not extend underneath the lifting boom to allow the use of the working platform and a compact folded transportation position in which the pendulum arm is folded underneath the lifting boom making it impossible to use the working platform are known, as illustrated in the international application WO 2018/229381, wherein it is possible to change from one position to another using a remote control unit.

Such a lift is moved on the ground from the working platform or from a control console disposed on the chassis. Such a lift allows the operator to control the change in position of the lift from the working position to the compact folded transportation position without having to climb onto the trailer or the flatbed that are used for transporting the lift from one point to another, it being necessary to perform this transport in the compact folded transportation position of the lift owing to its bulk. It is therefore current practice for an operator who is on the working platform to move the lift so as to bring the lift onto the flatbed or the trailer and then for a remote control unit to control the change in position of the lift from the working position to the compact folded transportation position.

This solution is not entirely satisfactory because, if maneuvers as described in patent US 2019/0233270 are not performed, it does not make it possible to avoid injury to the operator, notably when they are getting off the working platform after having positioned the chassis of the lift on the flatbed or the trailer on which it is loaded.

An aim of the invention is to provide a method for loading an aerial lift onto a trailer or a flatbed truck, and an aerial lift which is capable of implementing the method, the designs of which make it possible to limit the risks of an accident without adversely affecting the simplicity of the aerial lift.

Another aim of the invention is to provide a method for loading an aerial lift onto a trailer or a flatbed truck, and an aerial lift which is capable of implementing the method, the designs of which make it possible to dissuade, or even prevent, the operator from loading the aerial lift onto a trailer or flatbed truck from the working platform.

To this end, an object of the invention is a method for loading an aerial lift onto a trailer or a flatbed truck, said lift comprising a chassis provided with members for movement on the ground defining a plane in which the chassis rests on the ground when the chassis is positioned on a horizontal flat surface, a working platform comprising a floor and a guard rail, a lifting structure, a telecontrol unit also referred to as remote control unit and an operating unit configured to make at least the lifting structure and the working platform move according to at least data supplied by the remote control unit, said lifting structure comprising at least a lifting boom and a pendulum arm coupled at one end to the lifting boom and at the opposite end to the working platform, said lifting boom being a boom which can pivot between a topmost position and a bottommost position, this bottommost position corresponding to the position in which the lifting boom is lowered all the way down and/or the position in which at least part of the working platform makes contact with the ground, and said lift having, in addition to a working position, a compact folded transportation position in which the pendulum arm is folded underneath the lifting boom and the lifting boom is in the bottommost position, characterized in that, with the operating unit being configured to make the members for movement on the ground move according to at least data supplied by the remote control unit and the lift having an intermediate folded position referred to as loading position in which the pendulum arm is folded underneath the lifting boom and the lifting boom is not in the bottommost position, the method comprises, in order to load said aerial lift onto a trailer or a flatbed truck, a step of making the lifting structure and the working platform move up to said loading position and a step of using the remote control unit to make the members for movement of the chassis on the ground move in order to position the lift, which is in the loading position, on the flatbed truck or the trailer.

The expression “at least part of the working platform makes contact with the ground” is understood to mean that at least part of the working platform extends in a plane which coincides with the plane in which the chassis rests on the ground defined by the members for movement on the ground. In other words, it is understood that at least part of the working platform and the plane in which the chassis rests on the ground are coplanar.

“Remote control unit” is understood to mean a control unit which can be actuated by the operator from a location away from the chassis or the working platform. The combination of a remote control unit which can be actuated by an operator from a location away from the chassis or the working platform with an aerial lift which has a working position in which the floor of the working platform extends substantially horizontally, which is to say give or take 5° with respect to the horizontal, a compact folded transportation position and an intermediate folded position referred to as loading position in which the angle of inclination of the lifting boom is greater than the angle of inclination of the lifting boom in the compact folded transportation position, makes it possible to prompt the operator to put the lift in the loading position before loading it onto a trailer or a flatbed truck. Specifically, putting the lift in the loading position means the operator has recourse to a less bulky aerial lift which is easier to drive in order to load it onto a trailer or a flatbed truck. The operator is therefore prompted to use this loading position. Putting the lift in the loading position, in which the pendulum arm is disposed underneath the lifting boom and the floor of the working platform is inclined with respect to the horizontal and/or the guard rail of the working platform extends at least partially underneath the floor of the working platform, prevents the operator from getting onto the working platform. The operator is then forced to use the remote control unit to make the chassis move via its members for movement on the ground. The idea of putting the lift in the loading position in which the working platform cannot be used owing to the pendulum arm being folded underneath the lifting boom makes it possible, while the lift is not still positioned on the flatbed truck or the trailer, to force the operator to use the remote control unit to bring the lift onto the flatbed truck or the trailer. Of course, the method for unloading the aerial lift from the trailer or the flatbed truck comprises a step of using the remote control unit to make the members for movement of the chassis on the ground move in order for the lift to descend from the flatbed truck or the trailer and a step of making the lifting structure and the working platform move up to the working position of the lift.

According to one embodiment of the invention, after the step of using the remote control unit to make the members for movement of the chassis on the ground move in order to position the lift, which is in the loading position, on the flatbed truck or the trailer, the method comprises, when the lift is positioned on the flatbed truck or the trailer, a step of using the remote control unit to make the lifting structure and the working platform move in order to position the lift in the compact folded transportation position. It is possible to change from the loading position to the compact folded transportation position by simply pivoting the lifting boom downward. This results in simplicity of implementation.

According to one embodiment of the invention, in the compact folded transportation position or in the loading position, the working platform occupies a position referred to as non-operational position, in which an operator is prevented from standing upright on the working platform. As a result, the operator is prompted to use the remote control unit in order to move the chassis on the ground.

According to one embodiment of the invention, in the compact folded transportation position or in the loading position, the working platform occupies a position in which the floor of the working platform is inclined with respect to the horizontal by an angle greater than 5° and/or the guard rail of the working platform extends at least partially underneath the floor of the working platform. The compact folded transportation position or the loading position are configured to prevent an operator from standing upright on the working platform, owing to the pendulum arm being folded underneath the lifting boom.

According to one embodiment of the invention, in the compact folded transportation position, the working platform can be at least partially interposed between the lifting boom and the pendulum arm. As a result, the risk of the working platform striking the surface on which the chassis is moving is reduced.

According to one embodiment of the invention, the method comprises, before the step of using the remote control unit to make the members for movement of the chassis on the ground move in order to position the lift, which is in the loading position, on the flatbed truck or the trailer, a step of securing the working platform to the lifting structure.

According to one embodiment, the method comprises, for the securing step and before the step of making the lifting structure and the working platform move up to said loading position, a step of making the lifting structure and/or the working platform move up to said compact folded transportation position. As a result, in the compact folded transportation position, the angle of inclination of the lifting boom is less than the angle of inclination of the lifting boom in the loading position, such that the securing is made easier.

According to one embodiment of the invention, in the working position of the lift, the guard rail extends above the floor and the floor extends substantially horizontally. The working position of the lift is a position in which an operator can stand upright on the working platform. The working position of the lift is a position in which the pendulum arm is deployed and forms an angle greater than 90° with the lifting boom and the floor of the working platform extends substantially horizontally, which is to say horizontally give or take 5° with respect to the horizontal. In the working position of the lift, the pendulum arm is not folded underneath the lifting boom.

Another object of the invention is an aerial lift able to be loaded onto a trailer or a flatbed truck, said aerial lift comprising a chassis provided with members for movement on the ground defining a plane in which the chassis rests on the ground when the chassis is positioned on a horizontal flat surface, a working platform comprising a floor and a guard rail, a lifting structure, a telecontrol unit also referred to as remote control unit and an operating unit configured to make the lifting structure and the working platform move according to at least the data supplied by the remote control unit, said lifting structure comprising a lifting boom and a pendulum arm coupled at one end to the lifting boom and at the opposite end to the working platform, said lifting boom being a boom which can pivot between a topmost position and a bottommost position, this bottommost position corresponding to the position in which the lifting boom is lowered all the way down and/or the position in which at least part of the working platform makes contact with the ground, and said lift having, in addition to a working position, a compact folded transportation position in which the pendulum arm is folded underneath the lifting boom and the lifting boom is in the bottommost position, characterized in that the lift has an intermediate folded position referred to as loading position in which the pendulum arm is folded underneath the lifting boom and the lifting boom is not in the bottommost position, in that the operating unit is configured to make the members for movement on the ground move according to at least data supplied by the remote control unit and in that the operating unit is configured to, in order to load said aerial lift onto a trailer or a flatbed truck, when the lift is not positioned on said trailer or a flatbed truck, make the lifting structure and the working platform move up to said loading position and, using the remote control unit, make the members for movement of the chassis on the ground move in order to position the lift, which is in the loading position, on the flatbed truck or the trailer.

The loading position of the lift, in which the pendulum arm of the lift is folded underneath the lifting boom, prevents an operator from standing upright on the working platform. This loading position therefore ultimately forces the user to use the remote control unit to maneuver the aerial lift in order to move the chassis on the ground.

According to one embodiment of the invention, the operating unit, which is configured to make the members for movement of the chassis on the ground move in order to position the lift, which is in the loading position, on the flatbed truck or the trailer, is also configured to, when the lift is positioned on the flatbed truck or the trailer, to use the remote control unit to make the lifting structure and the working platform move in order to position the lift in the compact folded transportation position.

It is possible to change from the loading position to the compact folded transportation position by simply pivoting the lifting boom in the downward direction of the lifting boom. This results in simplicity of implementation. The usual driver of the lift can thus leave the lift in the loading position at the site where it needs to be loaded onto a flatbed truck or trailer. The driver of the flatbed truck or the trailer uses the remote control unit to simply make the members for movement of the chassis on the ground move and the lifting boom lower in order to load the lift onto the flatbed truck or the trailer and to bring it into the compact folded transportation position.

According to one embodiment of the invention, said lift comprises a device for detecting a presence on the working platform and the operating unit is configured to make the lifting structure and the working platform move up to said loading position according to at least the data supplied by the device for detecting a presence on the working platform, the operating unit being configured to prevent the lifting structure and the working platform from being made to move up to said loading position when a presence on the working platform is detected by the detecting device. This disposition makes it possible to ensure the operational safety of the aerial lift. This design prevents the lift from being brought into the compact folded transportation position or into the loading position if an operator is present on the working platform.

According to one embodiment of the invention, the pendulum arm is coupled at one end to the lifting boom so as to be able to be lowered and raised with respect to the lifting boom by pivoting.

According to one embodiment of the invention, in the loading position or in the compact folded transportation position, the working platform occupies a position in which the floor of the working platform is inclined with respect to the horizontal by an angle greater than 5° and/or the guard rail of the working platform extends at least partially underneath the floor of the working platform.

According to one embodiment of the invention, in the loading position or in the compact folded transportation position, the working platform can be at least partially interposed between the lifting boom and the pendulum arm.

According to one embodiment of the invention, in the working position, the guard rail extends above the floor and the floor extends substantially horizontally.

The lift is configured to allow the implementation of a method for loading the aerial lift onto a trailer or a flatbed truck in accordance with what was described above.

### BRIEF DESCRIPTION OF THE DRAWINGS

The invention will be clearly understood on reading the following description of exemplary embodiments, with reference to the appended drawings, in which:

FIG. 1 shows a side view of an aerial lift according to the invention in the working position;

FIG. 1bis shows a side view of an aerial lift according to the invention in the compact folded transport position;

FIG. 2 shows a side view of an aerial lift according to the invention in the loading position while it is being moved on the ground using a remote control unit in order to be loaded onto a trailer or a flatbed truck;

FIG. 3 shows a side view of an aerial lift according to the invention in the loading position while it is being moved using a remote control unit onto a trailer or a flatbed truck;

FIG. 4 shows a side view of an aerial lift according to the invention in the loading position and when it is positioned on a trailer or a flatbed truck;

FIG. 5 shows a side view of an aerial lift according to the invention in the compact folded transportation position and when it is positioned on a trailer or a flatbed truck;

FIG. 6 shows a side view of an aerial lift according to the invention in the compact folded transportation position and when it is positioned on a trailer or a flatbed truck.

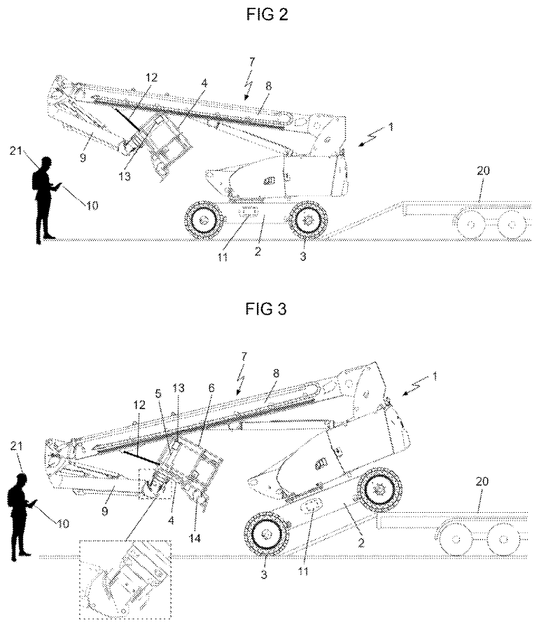

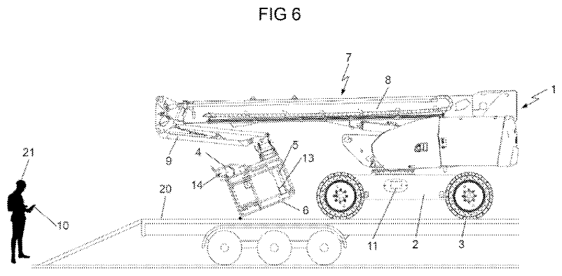

The invention relates to a lift 1 which is able, as illustrated in FIG. 2, to be loaded onto a trailer 20 or a flatbed truck in order to be transported or, as illustrated in FIGS. 5 and 6, unloaded from said trailer, to the method for loading said lift 1 onto the trailer 20 or a flatbed truck, and the resulting unloading method.

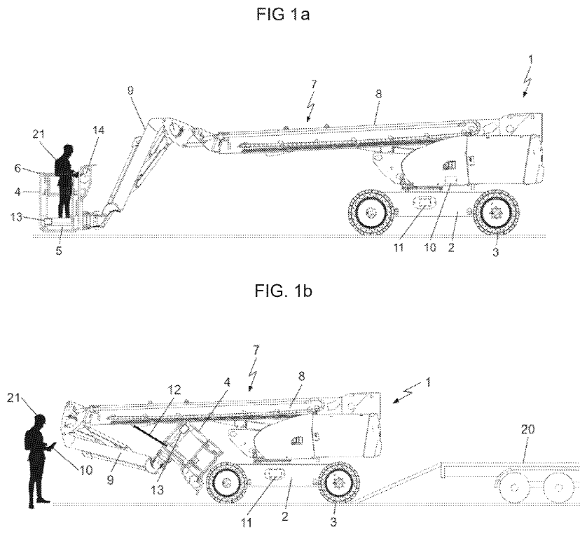

The lift 1 comprises a chassis 2 equipped with members 3 for movement on the ground in the form of wheels, like in the example shown, in which at least two of the wheels are preferably steered wheels. As an alternative or in addition, these members 3 for movement on the ground may comprise tracks. These members 3 for movement on the ground define a plane in which the chassis rests on the ground when the chassis is positioned on a horizontal flat surface. This plane corresponds, for example, to the line of the ground in FIG. 1.

The chassis 2 is equipped with an engine assembly, which is not shown, for ensuring notably the operation of the members 3 for movement of the chassis 2 on the ground and then the movement of the chassis 2.

This chassis 2 comprises a base on its own or a base surmounted by a turret, as in the examples shown.

This self-propelled chassis 2 will not be described in more detail because it is well known to those skilled in this art.

Irrespective of the design of the chassis 2, the aerial lift 1 comprises a lifting structure 7 borne by the chassis 2, and a working platform 4 on which an operator 21 can stand in order to control the aerial lift 1 from said working platform 4.

The presence of this working platform 4 makes it possible to work at height.

The working platform 4 conventionally comprises a floor 5 and a guard rail 6 surrounding the floor 5.

This working platform 4 is also provided with a control console 14 mounted fixedly or removably on the working platform 4. Such a control console 14 makes it possible to make the lifting structure 7 of the working platform 4 and the members 3 for moving the chassis 2 on the ground move. As a result, such a control console 14 makes it possible to raise and lower the working platform 4, depending on the desired position, and to move the chassis 2 on the ground.

To allow such control, the aerial lift 1 comprises an operating unit 11 capable of acquiring control data supplied by the control console 14 and controlling the movements of the aerial structure 7, of the members 3 for movement of the chassis on the ground and of the working platform 4 according to said data.

In general, the operating unit 11 is in the form of an electronic computer system which comprises, for example, a microprocessor and a working memory. According to a particular aspect, the operating unit may be in the form of a programmable automaton. In other words, the functions and steps described may be implemented in the form of a computer program or using hardware components (for example, programmable gate arrays). In particular, the functions and steps performed by the operating unit or its modules may be performed by sets of instructions or computer modules implemented in a processor or controller or may be performed by dedicated electronic components or components of the programmable logic circuit (or FPGA, which stands for field-programmable gate array) type or of the application-specific integrated circuit (ASIC) type. It is also possible to combine computer portions and electronic portions. When it is specified that the unit or means or modules of said unit are configured to perform a given operation, it means that the unit comprises computer instructions and the corresponding means of execution to allow said operation to be performed and/or that the unit comprises corresponding electronic components.

This operating unit 11 is preferably mounted on the chassis 2.

The aerial structure 7, for its part, comprises a lifting boom 8 and a pendulum arm 9.

The lifting boom 8 may be a telescopic or non-telescopic boom.

The pendulum arm 9 is coupled at one end to the lifting boom 8 so as to be able to be lowered and raised with respect to the lifting boom 8 by pivoting and at the opposite end to the working platform 4.

The lifting boom 8 is a pivoting boom mounted pivotably about an axis referred to as horizontal axis extending parallel to the surface of the ground when the chassis 2 is positioned on a horizontal flat surface. This pivoting movement of the lifting boom 8 makes it possible to change the boom from a bottommost position to a topmost position by varying its inclination with respect to the plane in which the chassis 2 rests on the ground. The bottommost position may correspond to the position in which the lifting boom 8 is lowered all the way down, as illustrated for example in FIGS. 1, 1bis, 5 and 6. This lowering of the lifting boom 8 all the way down is defined by the structure and generally corresponds to a position in which the lifting boom 8 bears against a mechanical stop formed in this case by the chassis 2 such that any lowering of the lifting boom 8 beyond this position is prevented. The bottommost position may also correspond to the position in which at least part of the working platform 4 makes contact with the ground, which is to say extends in the same plane as the plane in which the chassis 2 rests on the ground, as illustrated for example in FIG. 6. In this case, additional lowering of the boom, where possible, would cause damage to the working platform.

The bottommost position may also correspond to a combination of the two positions described above. This solution is the one illustrated in FIG. 6.

In the examples shown, the lifting boom 8 is pivotably coupled to the chassis 2, and the movement is performed using at least one actuator, such as a cylinder, disposed between the chassis 2 and the lifting boom 8. In a variant, the lifting boom may be pivotably coupled to an intermediate structure, which is itself coupled to the chassis 2.

Similarly, one or more actuators, such as cylinders, extend between the lifting boom 8 and the pendulum arm 9 to allow the lift to be changed from a working position, as illustrated in FIG. 1, in which the pendulum arm 9 does not extend underneath the lifting boom 8 and the guard rail 6 extends above the floor 5 and the floor 5 extends horizontally, such that an operator can stand upright on the working platform by standing on the floor 5 of the working platform 4, to a folded position, as illustrated in FIGS. 1bis to 6, in which the pendulum arm 9 is folded underneath the lifting boom 8 and forms an angle less than 90° with said pendulum arm 9.

When the pendulum arm 9 is in the folded state, which is to say in the position in which the pendulum arm 9 forms an angle less than 90° with the lifting boom 8 and the pendulum arm 9 extends at least partially underneath the lifting boom 8, the lift 1 may have several positions, specifically at least one compact folded transportation position, as illustrated in FIGS. 1bis, 5 and 6, in which the lifting boom 8 is in the bottommost position, and at least one intermediate folded position referred to as loading position, as illustrated in FIGS. 2 to 4, in which the lifting boom 8 is not in the bottommost position. In the figures, the loading position corresponds to a position in which the lifting boom 8 is not lowered all the way down, which is to say that the angle of inclination formed by the lifting boom 8 with respect to the plane in which the chassis 2 rests on the ground in the loading position is greater than the angle of inclination formed by the lifting boom with the plane in which the chassis 2 rests on the ground in the compact folded transportation position.

In practice, it is necessary at least to lower the lifting boom 8 in order, when the pendulum arm 9 is in the folded state, to allow the lifting boom 8 to be changed from the loading position to the compact folded transportation position. This lowering of the lifting boom 8 may be sufficient, as illustrated in the change from FIG. 2 to FIG. 5. In a variant, this lowering of the lifting boom 8 may be supplemented by a modification of the position of the working platform 4, as illustrated in the change from FIG. 2 to FIG. 6. In practice, therefore, in the loading position, the angle of inclination formed by the lifting boom 8 with the plane in which the chassis 2 rests on the ground is greater than the angle of inclination formed by the lifting boom 8 with the plane in which the chassis 2 rests on the ground in the compact folded transportation position.

In the loading position or the compact folded transportation position, the working platform 4 occupies a position referred to as non-operational position, in which an operator 21 is prevented from standing upright on the working platform 4. In particular, in the loading position or the compact folded transportation position, the working platform 4 occupies a position in which the floor 5 of the working platform 4 is inclined with respect to the horizontal and/or the guard rail of the working platform 4 extends at least partially underneath the floor 5 of the working platform 4, as illustrated in FIG. 2 in which the working platform is upside down, with its opening delimited by the guard rail 6 facing the ground and not the sky, as shown in FIG. 1.

It will be noted that, in the loading position or in the compact folded transportation position, the working platform 4 can be at least partially interposed between the lifting boom 8 and the pendulum arm 9, as illustrated in FIGS. 3 to 5, thereby making it possible to avoid damage to the working platform 4.

At least in the compact folded transportation position, the working platform 4 may be secured to the lifting structure 7, in particular to the lifting boom 8 by cords 12 or the like, as illustrated in FIG. 1bis.

In the working position, the pendulum arm 9 forms an angle greater than 90° with the lifting boom 8. The connection between the pendulum arm 9 and the working platform 4 is also at least one pivot connection, which is shown in detail in FIG. 3.

This pivot connection with a pivot axis parallel to the pivot axis of the lifting boom 8 in relation to the chassis or of the pendulum arm 9 in relation to the lifting boom 8 allows the working platform to pivot to either side of the arm so as to extend along one side or the other of the arm, as illustrated in FIGS. 1 and 3 for example, in which the working platform changes from a position with its opening facing the sky to a position with its opening facing the ground parallel to the fold of the pendulum arm underneath the lifting boom.

The working platform 4 may also, when the floor is positioned horizontally, pivot about a vertical axis for a lateral rightward or leftward movement of said working platform 4.

To complete the set, the lift 1 comprises a telecontrol unit also referred to as remote control unit 10. This remote control unit 10 may be connected to the operating unit 11 by a wired or wireless connection.

This remote control unit 10 may be formed by the control console 14 when the latter is mounted removably on the working platform 4. This remote control unit 10 may also consist of a movable terminal provided, for example, with a screen running a dedicated application, notably a smartphone. The screen may be a touchscreen and a display of specific instructions can allow the lift 1 to be remotely controlled. This remote control unit 10 can make it possible to initiate a sequence of predetermined movements and/or displacements of the lift 1.

Irrespective of the design of the remote control unit 10, the latter allows the operator 21 to control the lifting structure 7, the working platform 4 and the members 3 for movement of the chassis 2 on the ground, from a location away from the chassis 2 and the working platform 4 for the operator, as illustrated in FIG. 3.

Again, the operating unit 11 as described above is configured to acquire data from the remote control unit 10 and make the lifting structure 7, the working platform 4 and the members 3 for moving the chassis 2 on the ground move according to said data. Pre-stored movement sequences can possibly be stored in memory and initiated from the remote control unit 10 in order to make the work of the operator 21 easier.

To complete the aerial lift 1, said lift 1 may comprise a device 13 for detecting a presence on the working platform 4. This detecting device 13 may be in the form of a load sensor disposed in the floor of the working platform.

The operating unit 11 is configured to make the lift 1 change from the working position to the compact folded transportation position according to at least the data supplied by the remote control unit 10 and by the device 13 for detecting a presence on the working platform 4.

The operating unit 11 is thus configured to prevent the remote control unit 10 from making the lift 1 change from the working position to the compact folded transportation position when the detecting device 13 detects a presence on the working platform 4. Similarly, the operating device 11 is configured to make the lifting structure 7 and the working platform 4 move up to said loading position according to at least the data supplied by the device 13 for detecting a presence on the working platform 4, the operating unit 11 being configured to prevent the lifting structure 7 and the working platform 4 from being made to move up to said loading position when the detecting device 13 detects a presence on the working platform 4.

With an aerial lift 1 as described above, the method for loading the aerial lift 1 onto a trailer 20 or a flatbed truck is carried out as illustrated in FIGS. 2 to 4.

It is assumed that the lift 1 is resting on the ground and is in the working position as illustrated in FIG. 1 and that the operator has left the working platform, such that the device 13 for detecting a presence on the working platform, if present, no longer detects a presence on the working platform.

In all cases, the loading method comprises, in order to load the aerial lift 1 onto a trailer 20 or a flatbed truck, a step of making the lifting structure 7 and the working platform 4 move up to said loading position and a step of using the remote control unit 10 to make the members 3 for movement of the chassis 2 on the ground move in order to position the lift 1, which is in the loading position, on the flatbed truck or the trailer 20, as illustrated in FIGS. 2 to 4. Ideally, after the step of using the remote control unit 10 to make the members 3 for movement of the chassis 2 on the ground move in order to position the lift 1, which is in the loading position, on the flatbed truck or the trailer 20, the method comprises, when the lift 1 is positioned on the flatbed truck or the trailer 20, a step of using the remote control unit 10 to make the lifting structure 7 and the working platform 4 move in order to position the lift 1 in the compact folded transportation position, as illustrated in FIGS. 5 and 6. It is possible to change from the loading position to the compact folded transportation position by simply lowering the lifting boom 8, as illustrated in FIG. 5.

The loading method may comprise, before the step of using the remote control unit 10 to make the members 3 for movement of the chassis 2 on the ground move in order to position the lift 1, which is in the loading position, on the flatbed truck or the trailer 20, a step of securing the working platform 4 to the lifting structure 7.

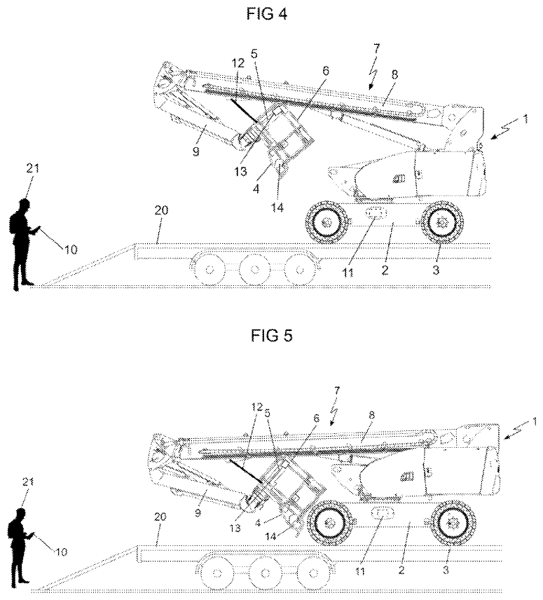

In this case, the method for loading the aerial lift 1 onto a trailer 20 or a flatbed truck comprises a step, preferably using the remote control unit 10, of making the lifting structure 7 and the working platform 4 move from the working position to the compact folded transportation position, as illustrated in FIG. 1bis, for lashing down purposes and then a step of making the lifting structure 7 and the working platform 4 move up to the loading position at least by raising the lifting boom 8 as illustrated in FIG. 2, and then a step of using the remote control unit 10 to make the members 3 for movement of the chassis 2 on the ground move in order to position the lift 1, which is in the loading position, on the flatbed truck or the trailer 20 by way of movement using the members 3 for movement on the ground, as illustrated in FIGS. 3 and 4.

When the lift is positioned on the flatbed truck or the trailer 20, the method comprises a step of using the remote control unit 10 to make the lifting structure 7 and the working platform 4 move in order to position the lift 1 in the compact folded transportation position by simply lowering the lifting boom 8 as illustrated in FIG. 5, or by lowering the lifting boom 8 and modifying the position of the working platform 4, as illustrated in FIG. 6.

In order to unload the aerial lift 1 from the trailer 20 or a flatbed truck, the unloading method comprises a step of using the remote control unit 10 to make the lifting structure and the working platform move in order to change into a loading position, a step of using the remote control unit to make the members 3 for movement of the chassis 2 on the ground move in order to allow the lift, which is in the loading position, to leave the trailer 20 or the flatbed truck, and a step of using the remote control unit to make the lifting structure 7 and the working platform move up to the working position. In this working position, an operator can get onto the working platform in order to then control the aerial lift 1 from the working platform 4.

It should be noted that an additional control unit, solely for the lifting structure and the working platform, may be provided at the chassis 2, this additional control unit being accessible to an operator from the ground.

1. A method for loading an aerial lift onto a trailer or a flatbed truck, the aerial lift including
a chassis provided with members for movement on the ground defining a plane on which the chassis rests on the ground when the chassis is positioned on a horizontal flat surface,
a working platform including a floor and a guard rail,
a lifting structure,
a remote control unit, and
an operating unit configured to make at least the lifting structure and the working platform move according to at least data supplied by the remote control unit,
the lifting structure including at least
a lifting boom, and
a pendulum arm having a first end and a second end, the first end being coupled to the lifting boom and the second end being coupled to the working platform, the lifting boom being a boom that can pivot between a topmost position and a bottommost position, the bottommost position corresponding to one or both of a position in which the lifting boom is lowered all the way down or a position in which at least part of the working platform makes contact with the ground,
wherein the aerial lift has a working position and a compact folded transportation position in which the pendulum arm is folded underneath the lifting boom and the lifting boom is in the bottommost position, wherein the operating unit is configured to make the members for movement on the ground move according to at least data supplied by the remote control unit and the aerial lift having an intermediate folded position in which the pendulum arm is folded underneath the lifting boom and the lifting boom is not in the bottommost position, the method comprising, in order to load the aerial lift onto the trailer or the flatbed truck;
a step of making the lifting structure and the working platform move up to the intermediate folded position; and
a step of using the remote control unit to make the members for movement of the chassis on the ground move in order to position the aerial lift, which is in the intermediate folded position, onto the flatbed truck or the trailer.

2. The method of claim 1, wherein after the step of using the remote control unit to make the members for movement of the chassis on the ground move in order to position the aerial lift, which is in the intermediate folded position, onto the flatbed truck or the trailer, the method further comprises a step of using the remote control unit to make the lifting structure and the working platform move in order to position the aerial lift in the compact folded transportation position while the aerial lift is positioned on the flatbed truck or the trailer.

3. The method of claim 1, wherein in one or both of the compact folded transportation position or the intermediate folded position an operator is prevented from standing upright on the working platform.

4. The method of claim 1, wherein in one or both of the compact folded transportation position or the intermediate folded position, the working platform occupies a position in which the floor of the working platform is inclined with respect to the horizontal flat surface by an angle greater than 5° or the guard rail of the working platform extends at least partially underneath the floor of the working platform.

5. The leading method of claim 1, wherein in the compact folded transportation position, the working platform can be at least partially interposed between the lifting boom and the pendulum arm.

6. The method of claim 1, further comprising a step of securing the working platform to the lifting structure before the step of using the remote control unit to make the members for movement of the chassis on the ground move in order to position the aerial lift, which is in the intermediate folded position, onto the flatbed truck or the trailer.

7. The method of claim 6, further comprising a step of making one or both of the lifting structure or the working platform lower down to the compact folded transportation position for the step of securing the working platform to the lifting structure and before the step of making the lifting structure and the working platform move up to the intermediate folded position.

8. The method of claim 1, wherein in the working position of the aerial lift, the guard rail extends above the floor and the floor extends substantially horizontally.

9. An aerial lift configured to be loaded onto a trailer or a flatbed truck, the aerial lift comprising:
a chassis provided with members for movement on the ground defining a plane on which the chassis rests on the ground when the chassis is positioned on a horizontal flat surface;
a working platform including a floor and a guard rail;
a lifting structure;
a remote control unit;
and an operating unit configured to make the lifting structure and the working platform move according to at least data supplied by the remote control unit, the lifting structure including a lifting boom and a pendulum arm having a first end and a second end, the first end being coupled to the lifting boom and the second end being coupled to the working platform, the lifting boom being a boom that can pivot between a topmost position and a bottommost position, the bottommost position corresponding to one or both of a position in which the lifting boom is lowered all the way down or a position in which at least part of the working platform makes contact with the ground,
wherein the aerial lift has a working position and a compact folded transportation position in which the pendulum arm is folded underneath the lifting boom and the lifting boom is in the bottommost position,
wherein the aerial lift has an intermediate folded position in which the pendulum arm is folded underneath the lifting boom and the lifting boom is not in the bottommost position,
wherein the operating unit is configured to make the members for movement on the ground move according to at least data supplied by the remote control unit, and
wherein the operating unit is configured to, in order to load the aerial lift onto the trailer or the flatbed truck, and when the aerial lift is not positioned on the trailer or the flatbed truck, make the lifting structure and the working platform move up to the intermediate folded position and, using the remote control unit, make the members for movement of the chassis on the ground move in order to position the aerial lift, which is in the intermediate folded position, onto the flatbed truck or the trailer.

10. The aerial lift of claim 9, wherein the operating unit, which is configured to make the members for movement of the chassis on the ground move in order to position the aerial lift, which is in the intermediate folded position, onto the flatbed truck or the trailer, is also configured to, when the aerial lift is positioned on the flatbed truck or the trailer, use the remote control unit to make the lifting structure and the working platform move in order to position the aerial lift in the compact folded transportation position.

11. The aerial lift of claim 9, wherein the aerial lift comprises a device for detecting a presence on the working platform and the operating unit is configured to make the lifting structure and the working platform move up to the intermediate folded position according to at least the data supplied by the device for detecting a presence on the working platform, the operating unit being configured to prevent the lifting structure and the working platform from being made to move up to the intermediate folded position when the device detects a presence on the working platform.

12. The aerial lift of claim 9, wherein the pendulum arm is coupled at the first end to the lifting boom so as to be able to be lowered and raised with respect to the lifting boom by pivoting.

13. The aerial lift of claim 9, wherein in one or both of the intermediate folded position or in the compact folded transportation position, the working platform occupies a position in which the floor of the working platform is inclined with respect to the horizontal flat surface by an angle greater than 5° or the guard rail of the working platform extends at least partially underneath the floor of the working platform.

14. The aerial lift of claim 9, wherein in one or both of the intermediate folded position or the compact folded transportation position, the working platform can be at least partially interposed between the lifting boom and the pendulum arm.

15. The aerial lift of claim 9, wherein in the working position, the guard rail extends above the floor and the floor extends substantially horizontally.

16. An aerial lift comprising:
a chassis including one of wheels or tracks;
a working platform;
a lifting structure; and
a telecontrol unit and an operating unit configured to actuate the lifting structure and the working platform, the lifting structure including a lifting boom pivotably connected to the working platform and to a pendulum arm,
wherein in a compact folded transportation position, the pendulum arm is folded under the lifting boom and the lifting boom is fully lowered,
wherein in a loading position, the pendulum arm is folded under the lifting boom and the lifting boom is at least partially raised,
wherein the operating unit is configured to move the wheels or the tracks based on data from the telecontrol unit, and
wherein, to load the aerial lift onto a transport vehicle, the operating unit is configured to move the lifting structure and the working platform into the loading position.

17. The aerial lift of claim 16, wherein the operating unit is configured to, after the aerial lift is positioned on the transport vehicle, move the lifting structure and the working platform into the compact folded transportation position.

18. The aerial lift of claim 16, wherein
a presence detector is mounted on the working platform,
the operating unit is configured to move the lifting structure and the working platform into the loading position based on data from the presence detector,
the operating unit is configured to prevent the lifting structure and the working platform from moving into the loading position when the presence detector detects a presence on the working platform.

19. The aerial lift of claim 16, wherein pivoting the lifting boom relative to the chassis raises and lowers the pendulum arm.

20. The aerial lift of claim 16, wherein in one or both of the loading position or the compact folded transportation position, a floor of the working platform is inclined with respect to a horizontal ground surface by an angle greater than 5° and a guard rail of the working platform extends at least partially under the floor.
